(19) United States
(12) Patent Application Publication
(10) Pub. No.: US 2024/0104839 A1
(43) Pub. Date: Mar. 28, 2024

(54) INFORMATION PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventor: HIDETOSHI TSUBAKI, Kanagawa (JP)

(21) Appl. No.: 18/458,192

(22) Filed: Aug. 30, 2023

(30) Foreign Application Priority Data
Sep. 22, 2022 (JP) 2022-151103

(51) Int. Cl. G06T 17/00; G06T 7/70; H04N 23/69

(52) U.S. Cl. CPC G06T 17/00; G06T 7/70; H04N 23/69

(57) ABSTRACT

An information processing apparatus is configured to provide imaging assisting information for an object to a user of an image pickup apparatus to collect images for generating a three-dimensional model of the object. The information processing apparatus includes a memory storing instructions, and a processor configured to execute the instructions to acquire object information including an image of the object, acquire a provisional three-dimensional model including an uncaptured part of the object upon inputting of the object information, calculate imaging range information including position-posture of the image pickup apparatus with respect to the object for the acquired image of the object and including a view angle range with respect to the object for the image of the object, and generate the imaging assisting information for the object based on the imaging range information.

### BACKGROUND

### Technical Field

One of the aspects of the embodiments relates to an information processing apparatus and particularly relates to an information processing apparatus configured to collect images for generating a three-dimensional (3D) model of an object.

### Description of Related Art

Various technologies recently disclosed not only capture a 2D image for viewing but also generate a three-dimensional model of an object that is an object such as a person, an animal, a chair, or a desk or is a gigantic object such as a car, a building, or a monument. Such generated three-dimensional models are increasingly utilized as elements constituting a virtual reality (VR) space or a mixed reality (MR) space in, for example, e-commerce, entertainment, and an SNS such as a metaverse.

An RGB camera such as a still camera or a movie camera, an RGBD sensor such as a time-of-flight (TOF) sensor, or a depth (D) sensor is used in information collection for generating a three-dimensional model. A plurality of still images or moving image frames are captured from the circumference of an object without omissions, and three-dimensional reconstruction is performed to obtain a three-dimensional model. In a recently dominant approach, images are acquired by an RGB camera instead of a three-dimensional sensor configured to obtain special RGBD images or depth images, from viewpoints of three-dimensional model quality and convenience, and a multi-view stereo (MVS) method is applied to the images to perform three-dimensional model generation.

However, an RGB image does not have three-dimensional information about an object. Thus, it is difficult to understand, from the RGB image, for which part of the object data is imaged by a camera in what position and posture, and which part of the object is an unacquired region. This is because, basically in three-dimensional reconstruction from RGB images, the position of the camera with respect to the object cannot be determined until all data is acquired and entirely three-dimensionally reconstructed.

With an RGBD sensor or depth sensor capable of obtaining a depth, depth data is three-dimensionally back-projected to perform positioning among frames by, for example, an ICP method or an NDT method. ICP is an abbreviation for iterative closest point. NDT is an abbreviation for normal distributions transform. Accordingly, acquired information about the frames is integrated to understand the relation among acquired data and the relation between the position-posture of a sensor camera and a view angle. Thus, in a basic approach, acquired local information is incrementally integrated along with gradual region expansion to establish a three-dimensional model. Thus, in a case where data of a gigantic object is acquired in pieces by a plurality of persons, it has been difficult to panoramically check omission, overlap, the completion rate, and the like until data acquisition ends for a most part of the object.

In a method disclosed in Japanese Patent Laid-open No. 2021-182175, information for generating three-dimensional model information is collected by a depth sensor and a three-dimensional model is generated through three-dimensional reconstruction, and then, imaging assist is performed based on the three-dimensional model when texture is collected by an RGB sensor.

However, in the above-described conventional technology disclosed in Japanese Patent Laid-open No. 2021-182175, a depth sensor, which is less common, needs to be used in addition to the RGB sensor to collect RGBD information with which a three-dimensional model can be reliably generated and to sequentially achieve imaging assist. In order to perform imaging assist in texture acquisition, data acquisition and three-dimensional model generation with the depth sensor need to be performed in advance. Furthermore, understanding of the state of acquisition in depth data acquisition is limited to state understanding of data of which acquisition-completed region is acquired from a sensor camera in what position and posture. It is difficult to perform panoramic presentation of the completion rate of data acquisition and perform imaging assist related to an unknown uncaptured region. Although it is possible to perform data acquisition and three-dimensional model generation with an RGB sensor only, it is not possible to perform imaging assist as disclosed in Japanese Patent Laid-open No. 2021-182175, which is based on prior three-dimensional model acquisition.

### SUMMARY

An information processing apparatus according to one aspect of the embodiment is configured to provide imaging assisting information for an object to a user of an image pickup apparatus to collect images for generating a three-dimensional model of the object. The information processing apparatus includes a memory storing instructions, and a processor configured to execute the instructions to acquire object information including an image of the object, acquire a provisional three-dimensional model including an uncaptured part of the object upon inputting of the object information, calculate imaging range information including position-posture of the image pickup apparatus with respect to the object for the acquired image of the object and including a view angle range with respect to the object for the image of the object, and generate the imaging assisting information for the object based on the imaging range information. An image pickup apparatus including the above information processing apparatus also constitutes another aspect of the embodiment. An information processing method corresponding to the above information processing apparatus also constitutes another aspect of the embodiment. A storage medium storing a program that causes a computer to execute the above information processing method also constitutes another aspect of the embodiment.

Further features of the disclosure will become apparent from the following description of embodiments with reference to the attached drawings.

### BRIEF DESCRIPTION OF THE DRAWINGS

FIG. 1 is a block diagram illustrating an exemplary configuration of an image pickup apparatus 100 according to a first embodiment;

FIG. 2 is a flowchart for description of the process of processing in the first embodiment;

FIGS. 3A and 3B are diagrams for description of acquisition of a provisional three-dimensional model;

FIG. 4 is a diagram for description of exemplary presentation of imaging assisting information;

FIG. 5 is a diagram for description of instruction for reimaging with imaging assist;

FIG. 6 is a block diagram illustrating an exemplary configuration of an image pickup apparatus 600 according to a second embodiment;

FIGS. 7A and 7B are explanatory diagrams of a case where an image of an object is captured by a plurality of persons; and

FIG. 8 is a diagram for description of a hardware configuration of a computer.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

FIG. 1 is a block diagram illustrating an exemplary configuration of an image pickup apparatus 100 according to a first embodiment. The image pickup apparatus 100 includes an imaging unit 101, an input I/F 102, and an output I/F (assisting information provision means) 106. The image pickup apparatus 100 additionally includes a provisional three-dimensional model acquiring unit (provisional three-dimensional model acquiring means) 103, an imaging range calculating unit (imaging range calculating means) 104, an assisting information calculating unit (assisting information generation means) 105, and an acquiring unit (acquiring means) 108. The acquiring unit 108, the provisional three-dimensional model acquiring unit 103, the imaging range calculating unit 104, the assisting information calculating unit 105 constitute an information processing apparatus 107. The information processing apparatus 107 of this embodiment provides imaging assisting information for an object to a user of the image pickup apparatus 100 to collect images for generating a three-dimensional model of the object.

In a case described in this embodiment, the information processing apparatus 107 is provided in the image pickup apparatus 100, but the present disclosure is not limited to the case. At least part of the configuration of the information processing apparatus 107 may be provided in an external server or cloud outside the image pickup apparatus 100. In this case, the image pickup apparatus 100 includes a network interface for communicating with the external server or cloud and transmits information to the acquiring unit 108 of the information processing apparatus 107 through the network interface.

The imaging unit 101 is a module that performs imaging and generates an image. The imaging unit 101 may be a monochrome camera or a color camera. The imaging unit 101 may be a three-dimensional sensor camera such as a TOF sensor capable of generating RGBD images. Alternatively, the imaging unit 101 may be a combination of a camera and a distance sensor that generates RGBD images, such as a light detection and ranging (LiDAR) sensor.

The input I/F 102 is an I/F for inputting information (object information) related to the object to the provisional three-dimensional model acquiring unit 103 to be described next. The input I/F 102 is, for example, a microphone that acquires the object information from a photographer as the user or a nearby person by voice. Alternatively, the input IF 102 is a keyboard or mouse that receives text inputting or candidate selection. Moreover, the input I/F 102 may be connected to, for example, a GPS or orientation sensor that obtains position-posture information about the image pickup apparatus 100 when the image is acquired by the imaging unit 101.

The acquiring unit 108 acquires the image captured by the imaging unit 101 and acquires the object information from the input I/F 102. Assume that the object information includes the image captured by the imaging unit 101. Accordingly, the acquiring unit 108 acquires the object information from the imaging unit 101 or the input I/F 102.

The provisional three-dimensional model acquiring unit 103 is a module that acquires or generates a provisional three-dimensional model based on the object information such as the image obtained from the imaging unit 101. The object information may be position-posture information about the object based on GPS information or orientation information obtained for the image pickup apparatus 100 by the GPS or the orientation sensor and acquired from the input I/F 102. Alternatively, the object information may be voice information or text information from the user. The object information may be, for example, text information or voice information such as “human body”, “upper body”, “face”, “house”, or “building”. The provisional three-dimensional model acquiring unit 103 acquires or generates a provisional three-dimensional model including an uncaptured part of the object in imaging by the imaging unit 101.

The imaging range calculating unit 104 calculates imaging range information including the position-posture of the image pickup apparatus 100 with respect to the object for the image (captured image) captured by the imaging unit 101 and including a view angle range with respect to the object for the image. The imaging range calculating unit 104 may calculate the view angle range and the position-posture for each of a plurality of captured images.

The assisting information calculating unit 105 is a module that calculates or generates, based on the imaging range information obtained by the imaging range calculating unit 104, information on imaging assisting performed for the photographer. The assisting information calculating unit 105 may calculate, based on the imaging range information obtained by the imaging range calculating unit 104, the completion or incompletion rate of imaging of the object according to accumulated captured images. The assisting information calculating unit 105 may generate imaging assisting information indicating any image imaging omission region. The assisting information calculating unit 105 may generate, for an image with an imaging distance shorter than a predetermined distance, imaging assisting information that instructs imaging at a close distance or imaging with zoom-in. In a case where an image includes a focal point blur or a motion blur, is saturated due to significant error of exposure, or has a low exposure, the assisting information calculating unit 105 may generate imaging assisting information that instructs reimaging at the same viewpoint. The assisting information calculating unit 105 may perform three-dimensional local reconstruction among accumulated captured images, reproject a reconstructed shape and texture of a captured region onto the accumulated captured images, and evaluate the accuracy of a three-dimensional shape. The assisting information calculating unit 105 can sense a case where the accuracy of the three-dimensional shape is low based on large deviation of the reprojected shape from either image or texture blurring. In this case, the assisting information calculating unit 105 may generate imaging assisting information that instructs reimaging.

The output I/F 106 is configured as a device such as a display or speaker that provides such imaging assisting information to the photographer. The output I/F 106 presents the imaging assisting information generated by the assisting information calculating unit 105 or executes imaging assist based on the imaging assisting information. For example, the output I/F 106 displays the completion rate on the display, displays a provisional three-dimensional model on the display and indicates an imaging uncompleted site, or indicates a reimaging site. The output I/F 106 may convey the imaging assisting information to the user through the speaker or may convey a reimaging instruction to the user through vibration of a vibrator.

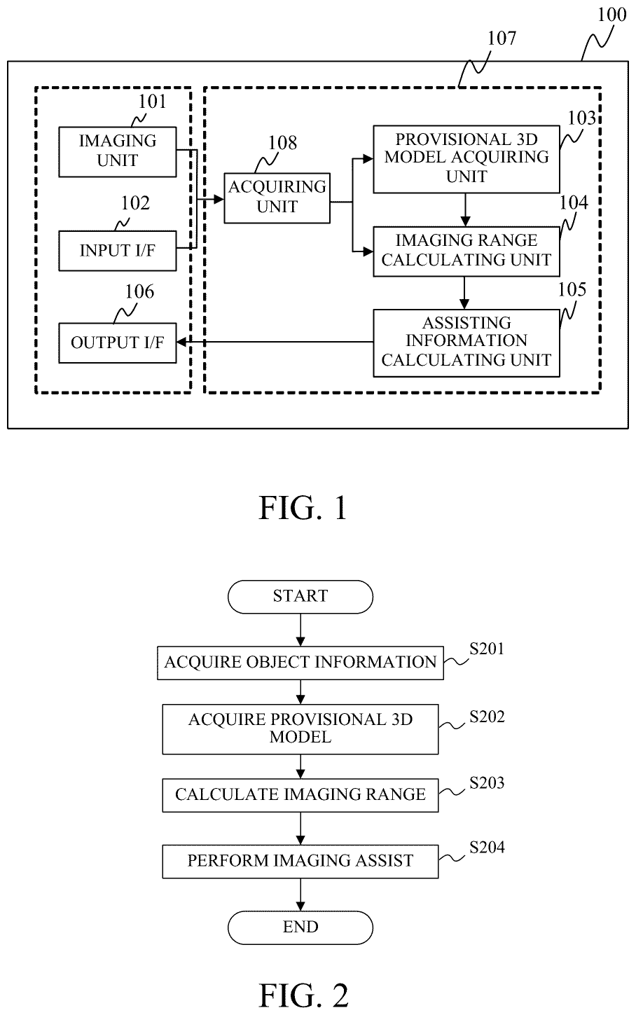

FIG. 2 is a flowchart for description of the process of processing in this embodiment.

An object information acquiring step S201 is a step of acquiring object information for generating a provisional three-dimensional model. At the object information acquiring step S201, the acquiring unit 108 acquires object information. An example of the object information is at least one image including at least part of the object. Another example of the object information is information such as text information or voice information about a word indicating the object. For example, in a case where the object is part of a human body, the object information is text information or voice information about a word such as “human body”, “upper body”, or “face”. The object information may be “house”, “car”, “motorcycle”, or the like, may be the specific name of a particular building at a specific sightseeing spot, or may be a specific car type name. Alternatively, an object positioned at the focusing distance when the camera is pointed toward the object may be regarded as the object information. For example, the object information may be the position-posture of the image pickup apparatus 100, which is obtained from the imaging unit 101 or the non-illustrated GPS or orientation sensor of the image pickup apparatus 100 at the moment. Moreover, the position-posture of the object may be acquired as the object information with the focusing distance taken into account.

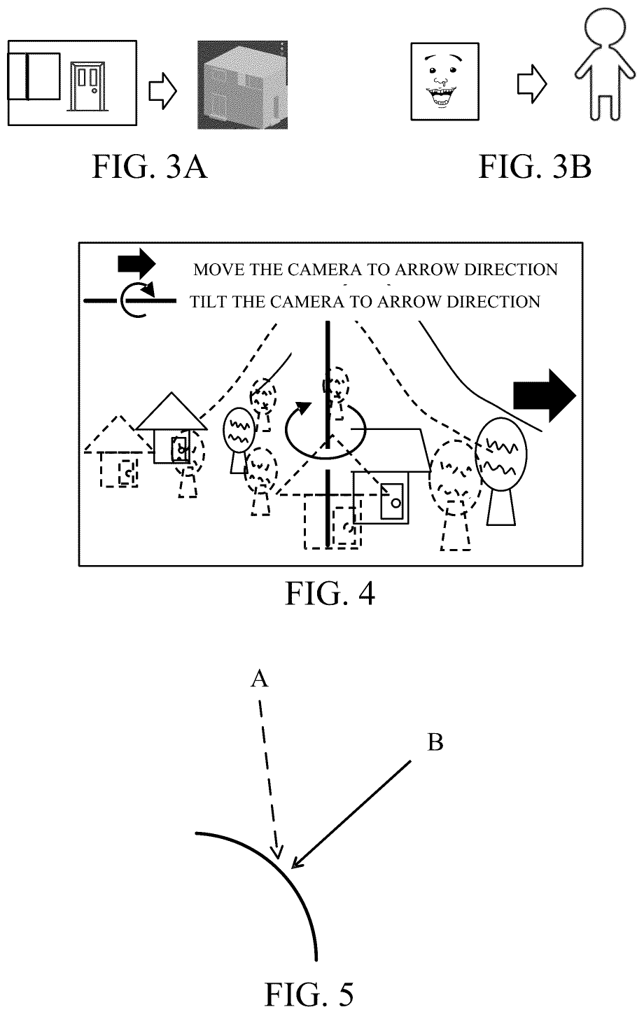

A provisional three-dimensional model acquiring step S202 is a step of acquiring a provisional three-dimensional model upon inputting of the object information. In an assumed case, the object information is an image and is a group of at least one image including only part of the object. For example, the object is so highly unique that nobody performs three-dimensional modeling of an object schematically similar thereto in some cases. In such a case, the provisional three-dimensional model acquiring unit 103 may acquire a provisional three-dimensional model by using a deep learning technology such as a GAN or NeRF at the provisional three-dimensional model acquiring step S202. GAN is an abbreviation for generative adversarial network. NeRF is an abbreviation for neural radiance fields. As illustrated in FIGS. 3A and 3B, the provisional three-dimensional model acquiring unit 103 acquires, from at least one image including part of the object, a provisional three-dimensional object by forming a convex-hull closed curved surface based on at least the shape of the object. FIG. 3A is a diagram illustrating an example in which a three-dimensional model of the entire object other than a ground contact surface is acquired from an image of part of a building. The image in FIG. 3A is part of a picture image of the vicinity of the entrance. Any part not included in an input image is generated in a provisional shape in accordance with properties of learning data and the like. Various technologies have been disclosed for generation of a three-dimensional model including such a part not included in an input image. Z Chen, et. al., “Multiresolution Deep Implicit Functions for three-dimensional Shape Representation”, ICCV2021, arxiv 2109.05591 describes an approach for defining a deep implicit function that handles hierarchic detailing and for generating a probable provisional three-dimensional model for any uncaptured part as well as a limited detailed part of an captured image.

FIG. 3B is a diagram for description of a case where a provisional three-dimensional model of a human body is generated based on an image of the object of a limited part such as a face. For example, S. Saito, et. al., “PIFuHD: Multi-Level Pixel-Aligned Implicit Function for High-Resolution three-dimensional Human Digitization” CVPR2020, arxiv 2004.00452 discloses a technology of generating a probable model of the back side of a three-dimensional model based on one image from the front side.

In a case of modeling of an object, such as a building at a sightseeing spot, which is repeatedly modeled by a large number of people and temporal change in which is acquired as a difference, the provisional three-dimensional model acquiring unit 103 stores past three-dimensional models acquired and accumulated in advance. Then, the provisional three-dimensional model acquiring unit 103 may select the object information as a search key and acquire and provide a provisional three-dimensional model. For example, in a case where the object information is an image including at least part of the object, the provisional three-dimensional model acquiring unit 103 provides, as a provisional three-dimensional model, a three-dimensional model of a similar object by using the image as key information. Such a method is applicable to, for example, the field of articles of taste, such as houses, cars, or motorcycles, which roughly have similar shapes but have differences in options. The stored past three-dimensional models may be not three-dimensional models that are three-dimensionally reconstructed by acquiring images with the same apparatus as the image pickup apparatus 100. For example, in a case where the image pickup apparatus 100 is a monochrome sensor, the provisional three-dimensional model may be produced from images acquired by a color sensor. The provisional three-dimensional model may be produced by a three-dimensional sensor such as a TOF or LiDAR sensor in advance or may be a three-dimensional model produced by a worker with CAD or three-dimensional sculpting software (three-dimensional editing software). The object information does not necessarily need to be images in a case where the provisional three-dimensional model is searched by using the object information as a search key. The object information may be text information about a word such as “building”, “house”, “high-rise building”, “car”, “human body”, “upper body”, or “face” or may be voice information thereof. The provisional three-dimensional model may be acquired by searching with more specific key information such as “car type name”, “male”, or “female”. Position information about the GPS or orientation information about the orientation sensor may be used as key information in acquisition of the provisional three-dimensional model. Depth (D) image information may be used as key information for provisional three-dimensional model search in a case where the imaging unit 101 additionally uses a RGBD sensor such as a TOF or LiDAR sensor and depth information is simultaneously obtained.

The provisional three-dimensional model is guide information for imaging images that cover the convex-hull closed curved surface of the object with multi-shot images from multiple viewpoints by the image pickup apparatus 100 thereafter. Thus, the provisional three-dimensional model does not necessarily need to be the object itself, and the provisional three-dimensional model acquiring unit 103 may sequentially update the provisional three-dimensional model based on the object information that increases in accordance with images obtained by imaging.

In a case where the provisional three-dimensional model searched and acquired by using the object information is largely different from the object, the provisional three-dimensional model acquiring unit 103 may update the provisional three-dimensional model with additional object information. When object information is added from the input I/F 102 through the acquiring unit 108 by the photographer, the provisional three-dimensional model acquiring unit 103 performs search for the provisional three-dimensional model by using the additional object information as well. The provisional three-dimensional model acquiring unit 103 may perform search for the provisional three-dimensional model after the photographer cancels previous search and inputs the object information from a blank state through the input I/F 102.

The provisional three-dimensional model acquiring unit 103 may generate the provisional three-dimensional model by classical multi-view stereoscopic processing in a case where the object information is images and constituted by a small number of images captured from the entire circumference of the object. The provisional three-dimensional model can be generated by the classical method in a case where the object is adjacent to no other object and images of the object information obtained by regarding a surface other than a ground contact surface as a convex-hull closed curved surface substantially cover the entire object and constitute the closed curved surface. In an assumed case, it is desired to generate the provisional three-dimensional model with coarse information by imaging a small number of images of the entire object at distant places and produce a more accurate three-dimensional geometric model or a three-dimensional model with high definition texture through main imaging of a large number of images at closer places. However, in this case, great amounts of work and time are need for collection of the object information at the previous step.

An imaging range calculating step S203 is a step of calculating the imaging range information including the position-posture of the image pickup apparatus 100 with respect to the object for an captured image and the view angle range with respect to the object for the captured image. At the imaging range calculating step S203, the imaging range calculating unit 104 calculates the imaging range information. In addition, at the imaging range calculating step S203, the assisting information calculating unit 105 calculates the completion and incompletion rates of imaging of the convex-hull closed curved surface of the object and any image imaging omission region thereof based on accumulated captured images. The assisting information calculating unit 105 calculates these values based on the provisional three-dimensional model and a three-dimensional model three-dimensionally reconstructed from the accumulated captured images. The assisting information calculating unit 105 basically calculates the view angle range with respect to the object for each of sequentially input images based on the accumulated captured images and the three-dimensional model three-dimensionally reconstructed with these images as input, and the position-posture of the image pickup apparatus 100 with respect to the object. Then, the assisting information calculating unit 105 updates the imaging completion and incompletion rates and information about any image imaging omission region.

In the calculation of the view angle range and the position-posture, positioning is performed for a three-dimensional model of a part back-projected from images for the provisional three-dimensional model by an ICP method in a case where, for example, the image pickup apparatus 100 is a module configured to output RGBD images. In this manner, the view angle range and the position-posture of the image pickup apparatus 100 with respect to the object at imaging are calculated.

In a case where the imaging unit 101 is an RGB camera or a monochrome image camera, the number of accumulated images is increased as relative position-posture is calculated by PnP between images captured while the imaging unit 101 is overlapped with the provisional three-dimensional model as an initial value or a guide. Then, local three-dimensional reconstruction is trigonometrically performed with several images or more, and positioning by, for example, ICP or NDT is performed between a partial three-dimensional model thus obtained and the provisional three-dimensional model. Accordingly, the position-posture with respect to the object for each captured image and the view angle range for each image are calculated. Information is updated each time an captured image is newly input.

The provisional three-dimensional model may be sequentially updated to a more accurate model by using, as key information, an captured image or a three-dimensional model three-dimensionally reconstructed by using the captured image. The imaging completion and incompletion rates are recalculated in accordance with the imaging range region of the captured image for the surface of the new provisional three-dimensional model.

An imaging assisting step S204 is a step of providing the imaging assisting information to the photographer through the output IF 106. At the imaging assisting step S204, the output I/F 106 notifies, through the display, the photographer of a statistic such as the imaging completion or incompletion rate calculated by the imaging range calculating step S203. Alternatively, the output I/F 106 conveys information about the statistic by voice from the speaker. Alternatively, the output I/F 106 presents, on the display, at least one of the view angle range of each captured image or each position-posture. The output I/F 106 may display on the display, as an unacquired region, the other surface region of the provisional three-dimensional model than an imaged region in which the captured image is projected onto the surface of the provisional three-dimensional model. The display can be performed by, for example, a method of coloring the unacquired region on the model surface. Each captured image may be checked, and for example, the imaging assisting information for imaging again may be provided. For example, the imaging assisting information that instructs imaging at a closer distance or imaging with zoom-in may be provided in a case where the position of imaging is significantly far from the object. Alternatively, the imaging assisting information that instructs reimaging may be provided in a case where a motion blur or a focal point blur occurs to an captured image. The imaging assisting information that instructs position-posture so that reimaging can be performed in the vicinity of the previous position-posture may be provided in a case where reimaging is instructed.

FIG. 4 is a diagram for description of the procedure of presenting the imaging assisting information for position-posture through the display of the output I/F 106. In the example illustrated in FIG. 4, the imaging assisting information such as panning, tilting, rolling, forward, backward, rightward, leftward, upward, and downward movement, zoom-in, or zoom-out of the camera is provided. Blurs may be sensed by texture analysis such as Fourier analysis or by comparison with another captured image.

Position-posture with respect to the surface of the object is often not appropriate in a case where a three-dimensional model is generated from acquired images by multi-view stereoscopic processing or the like and its shape is deviated from a correct shape or an accurate shape or no probable shape is obtained. The accuracy of the three-dimensional shape is evaluated by locally performing three-dimensional reconstruction with accumulated captured images and reprojecting reconstructed shape and texture of a captured region onto the accumulated captured images. A case where the accuracy is low can be sensed because, for example, the reprojected shape is largely deviated with respect to any image or the texture is blurred. FIG. 5 is a diagram for description of an instruction for reimaging with imaging assist. The curved surface is an object surface, A is an initial imaging viewpoint, and a dotted line arrow is a line of sight in an initial position-posture. In a case where it is sensed that the shape of the object cannot be correctly acquired, a notification thereof or the imaging assisting information with which an image can be captured from a position-posture B is provided to the photographer through the output I/F 106. In this manner, in a case where a generated provisional three-dimensional model is deviated from its accurate shape, a notification that the accurate shape of the object cannot be acquired or an instruction for reimaging with a different imaging distance or imaging angle may be provided through the output I/F 106.

In this embodiment, the steps as described above are performed to efficiently collect images without omissions for generating a three-dimensional model of the object. Imaging is stopped once accumulative imaging of images without omissions is achieved for a provisional three-dimensional model set for the object.

### Second Embodiment

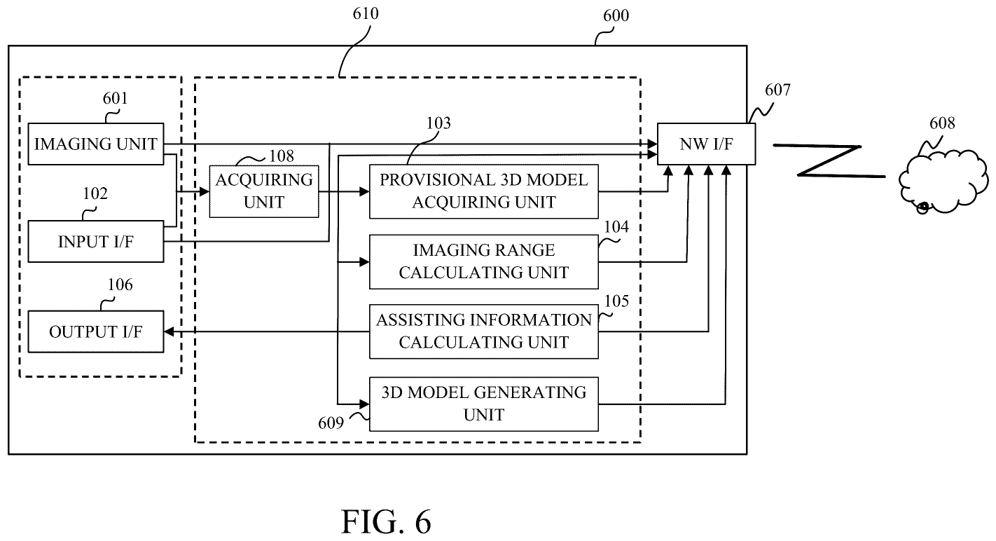

FIG. 6 is a block diagram illustrating an exemplary configuration of an image pickup apparatus 600 according to a second embodiment. The image pickup apparatus 600 includes an imaging unit 601, the input I/F 102, the provisional three-dimensional model acquiring unit 103, the imaging range calculating unit 104, and the assisting information calculating unit 105. In addition, the image pickup apparatus 600 includes the output I/F 106, a network interface (NW I/F) 607, and a three-dimensional model generating unit (three-dimensional model acquiring means) 609. The image pickup apparatus 600 is connected to a server or cloud 608 through the network interface 607. The acquiring unit 108, the provisional three-dimensional model acquiring unit 103, the imaging range calculating unit 104, the assisting information calculating unit 105, and a three-dimensional model generating unit 609 constitute an information processing apparatus 610. In the following, any functional element identical to that of the image pickup apparatus 100 of the first embodiment is denoted by the same reference sign and description thereof is omitted.

The imaging unit 601 may be, for example, a color or monochrome sensor, a three-dimensional sensor camera such as a TOF sensor capable of generating RGBD images, or combination of a camera and a LiDAR sensor as described above for the image pickup apparatus 100 in the first embodiment. In this embodiment, the imaging unit 601 is, for example, a pupil division sensor that is used in a mirrorless interchangeable lens camera or the like. This is an imaging unit capable of obtaining RGBD images like, for example, a three-dimensional sensor camera. In most cases, three-dimensional reconstruction is basically performed by only using RGB information, with distance information as auxiliary information, to generate three-dimensional model information.

The network interface 607 and the server or cloud 608 connected to the network interface 607 alternatively perform processing at the acquiring unit 108, the provisional three-dimensional model acquiring unit 103, the imaging range calculating unit 104, the assisting information calculating unit 105, and the three-dimensional model generating unit 609 in the image pickup apparatus 600. The network interface 607 is an I/F connected to an optional network such as a wired LAN, a wireless LAN, or Bluetooth (registered trademark) and is a means capable of establishing a state in which calculation and data communication are possible with the server or cloud 608 in the network. With connection to the server or cloud 608, it is possible to store an ample amount of provisional three-dimensional model information associated with the object information, and thus it is easier to acquire a more appropriate provisional three-dimensional model. Moreover, it is possible to select processing from among plenty of options for generation of a provisional three-dimensional model from partial images by deep learning processing.

The three-dimensional model generating unit 609 is a module configured to perform processing of generating a three-dimensional model from accumulated captured images. All processing at the three-dimensional model generating unit 609 may be performed by the server or cloud 608 connected to the network interface 607.

In a case described in this embodiment, as in the first embodiment, the information processing apparatus 610 is provided in the image pickup apparatus 600, but the present disclosure is not limited to the case. At least part of the configuration of the information processing apparatus 610 of this embodiment does not necessarily need to be provided in the image pickup apparatus 100 but may be provided in the external server or cloud 608 as long as the server or cloud 608 alternatively performs processing at the information processing apparatus 610. In this case, the image pickup apparatus 600 includes the network interface 607 for communicating with the server or cloud 608.

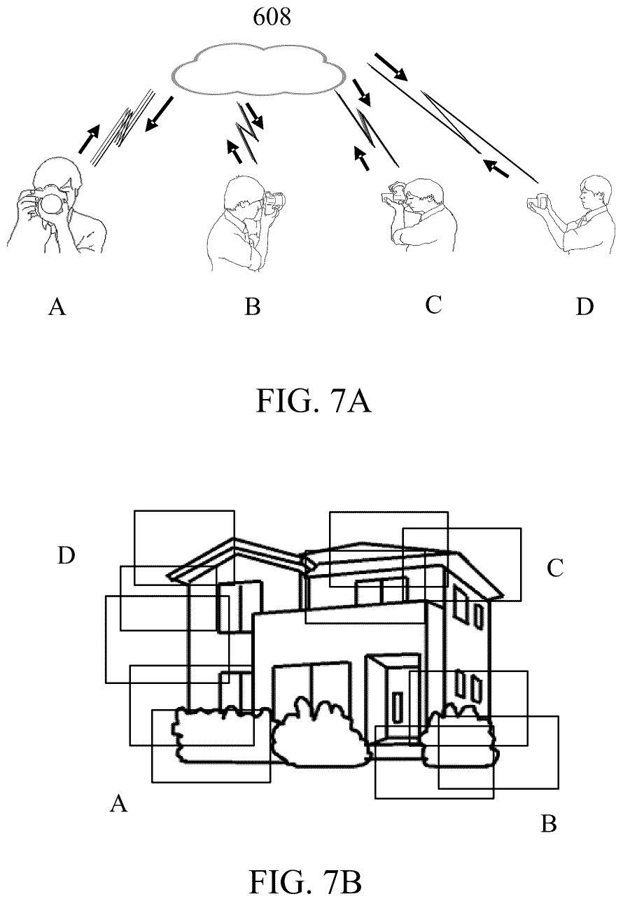

In the first embodiment, a case where one photographer captures images of an object is mainly described as a specific example. This imaging may be performed by a plurality of persons. FIGS. 7A and 7B are each a diagram for description of a case where images of an object is captured by a plurality of persons. As illustrated in FIG. 7A, the image pickup apparatus 600 of each of a plurality of persons participating in the imaging is connected through the network interface 607 to the same server or cloud 608 through which captured data can be shared. Captured images can be shared through the network interface 607. The server or cloud 608 transmits an image captured by each photographer to another photographer so that the other the photographer can share the image. Shared captured data may be used to calculate and present at least one of the imaging completion rate or the imaging incompletion rate or to perform imaging assist for any uncaptured region. Assist with imaging instructions may be performed for a photographer close to the uncaptured region. Alternatively, the imaging completion and incompletion rates may be calculated at the server or cloud 608 connected to the network interface 607 and may be presented on the display of the output I/F 106 as illustrated in FIG. 7B.

Rectangles in FIG. 7B are examples of imaging assist in which imaging ranges captured by photographers A, B, C, and D are overlaid on a provisional three-dimensional model. When the configuration of the image pickup apparatus 600 of this embodiment is employed, images can be collected by a plurality of persons, and thus image collection for generating a three-dimensional model of an object can be more efficiently performed. Moreover, the completion and incompletion rates of image acquisition can be panoramically understood in real time by the plurality of persons. Furthermore, omissions of images of the object can be understood in real time by the plurality of persons.

This embodiment can be achieved as described below. Program codes of software that implements functions of the above-described embodiments are recorded in a computer-readable recording medium (storage medium). Then, the recording medium is supplied to a system or apparatus including an imaging unit such as a camera, an input I/F such as a voice-text input unit, and an output I/F such as a display.

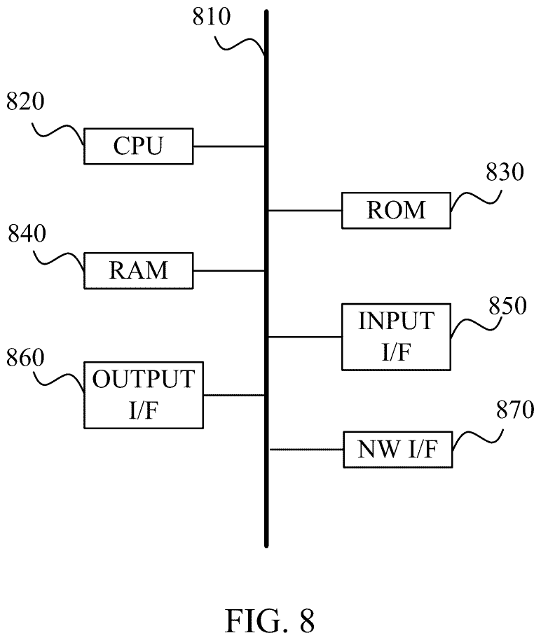

FIG. 8 is a block diagram illustrating a hardware configuration of such an apparatus or system. The apparatus or system includes a central processing unit (CPU) 820 configured to process computer programs, and a read only memory (ROM) 830 configured to store computer programs. The apparatus or system further includes a random access memory (RAM) 840 from and to which necessary data is read and written at execution of computer programs, an input I/F 850 as described above, an output I/F 860 as described above, and a network interface (NW I/F) 870. These components are connected to one another through a communication bus 810. The apparatus or system is configured as a computer apparatus including these components.

Then, a computer such as the CPU 820 of the system or apparatus reads and executes program codes stored in the recording medium. In this case, the program codes read from the recording medium implement the functions of the above-described embodiments, and the recording medium in which the program codes are recorded is included in the present example.

As the program codes read by the computer are executed, an operating system (OS) or the like that is operational on the computer performs part or all of actual processing based on instructions of the program codes. The functions of the above-described embodiments can be implemented by the processing as well.

Consider a case where the program codes read from the recording medium are written to a memory included in a functional extension card inserted into the computer or a functional extension unit connected to the computer. The network interface for a wired LAN, a wireless LAN, or the like is connected to a server or cloud including a database and a calculating means, the database storing significantly large numbers of three-dimensional models and associated search key images and words. Thereafter, part or all of actual processing is performed based on instructions of the program codes by, for example, a CPU or recording medium included in the functional extension card, the functional extension unit, or the server or cloud. The functions of the above-described embodiments can be implemented by the processing as well.

In a case where this embodiment is applied to the above-described recording medium, program codes corresponding to the above-described flowchart are stored in the recording medium.

This embodiment can provide an information processing apparatus that can acquire a provisional three-dimensional model including an uncaptured part of an object and provide imaging assisting information for subsequent image acquisition to a photographer.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-151103, filed on Sep. 22, 2022, which is hereby incorporated by reference herein in its entirety.

What is claimed is:

1. An information processing apparatus configured to provide imaging assisting information for an object to a user of an image pickup apparatus to collect images for generating a three-dimensional model of the object, the information processing apparatus comprising:
a memory storing instructions; and
a processor configured to execute the instructions to:
acquire object information including an image of the object,
acquire a provisional three-dimensional model including an uncaptured part of the object upon inputting of the object information,
calculate imaging range information including position-posture of the image pickup apparatus with respect to the object for the acquired image of the object and including a view angle range with respect to the object for the image of the object, and
generate the imaging assisting information for the object based on the imaging range information.

2. The information processing apparatus according to claim 1, wherein the object information includes at least one of an image including at least part of the object, GPS information and orientation information about the image pickup apparatus, voice information from the user, or text information from the user.

3. The information processing apparatus according to claim 1, wherein the processor is configured to generate the provisional three-dimensional model at a server or cloud outside the image pickup apparatus upon inputting of the object information.

4. The information processing apparatus according to claim 1, wherein the object information is an image including at least part of the object, and
wherein the processor is configured to generate the provisional three-dimensional model of the entire object from the image including at least part of the object.

5. The information processing apparatus according to claim 4, wherein the processor is configured to generate the provisional three-dimensional model of the entire object from the image including at least part of the object by using deep learning.

6. The information processing apparatus according to claim 1, wherein the object information is GPS information and orientation information about the image pickup apparatus, and
wherein the processor is configured to provide past provisional three-dimensional models accumulated in advance in association with the GPS information and orientation information.

7. The information processing apparatus according to claim 1, wherein the object information is at least one of text information or voice information, and
wherein the processor is configured to provide past provisional three-dimensional models accumulated in advance in association with at least one of the text information or the voice information.

8. The information processing apparatus according to claim 1, wherein the object information is an image including at least part of the object, and
wherein the processor is configured to acquire the provisional three-dimensional model by searching, with the image including at least part of the object as key information, past provisional three-dimensional models accumulated in advance in association with the image including at least part of the object.

9. The information processing apparatus according to claim 6, wherein the past provisional three-dimensional models accumulated in advance includes at least one of a three-dimensional model generated by collecting data acquired from the image pickup apparatus or a three-dimensional model generated by collecting data by using, instead or in addition, another image pickup apparatus or a depth sensor.

10. The information processing apparatus according to claim 1, wherein the processor calculates the imaging range information at a server or cloud outside the image pickup apparatus.

11. The information processing apparatus according to claim 1, wherein the processor acquires an image captured by the image pickup apparatus and transmits the image to another image pickup apparatus.

12. The information processing apparatus according to claim 1, wherein the processor acquires an image captured by the image pickup apparatus and calculates the imaging range information at a server or cloud outside the image pickup apparatus.

13. The information processing apparatus according to claim 1, wherein the imaging assisting information includes at least one of the position-posture or the view angle range.

14. The information processing apparatus according to claim 1, wherein the imaging assisting information includes an instruction for reimaging at a closer distance or an instruction for reimaging with zoom-in in a case where imaging distance of the image acquired for the object by the processor to the object is longer than a predetermined distance.

15. The information processing apparatus according to claim 1, wherein in a case where a motion blur or a focal point blur occurs to the image acquired for the object by the processor, the imaging assisting information includes an instruction for reimaging in position-posture close to the position-posture of the image pickup apparatus when the image of the object is captured.

16. The information processing apparatus according to claim 1, wherein the imaging assisting information includes at least one of a notification that an accurate shape of the object cannot be acquired or an instruction for reimaging with a different imaging distance or imaging angle, the notification and the instruction being issued in a case where the shape of the provisional three-dimensional model generated for the object upon inputting of the image acquired for the object by the processor is deviated from the accurate shape.

17. An image pickup apparatus comprising:
an imaging unit configured to capture an image of an object; and
the information processing apparatus according to claim 1.

18. The image pickup apparatus according to claim 17, further comprising an assisting information provision means for providing the imaging assisting information to the user.

19. An information processing method of providing imaging assisting information for an object to a user of an image pickup apparatus to collect images for generating a three-dimensional model of the object, the information processing method comprising:
an acquiring step of acquiring object information including an image of the object;
a provisional three-dimensional model acquiring step of acquiring a provisional three-dimensional model including an uncaptured part of the object upon inputting of the object information;
an imaging range calculating step of calculating imaging range information including position-posture of the image pickup apparatus with respect to the object for the acquired image of the object by the acquiring step and including a view angle range with respect to the object for the image of the object; and
an assisting information generation step of generating the imaging assisting information for the object based on the imaging range information.

20. A non-transitory computer-readable storage medium storing a computer program for causing a computer to execute the information processing method according to claim 19.
